(19) United States
(12) Patent Application Publication
(10) Pub. No.: US 2006/0242109 A1
(43) Pub. Date: Oct. 26, 2006

(54) Server-deployed cache list management for presenting an auto-complete list

(75) Inventors: Jorge Pereira, Seattle, WA (US); Linda R. Chen, Ithaca, NY (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/113,840

(22) Filed: Apr. 25, 2005

(51) Int. Cl. G06F 17/30

(52) U.S. Cl. 707/1

(57) ABSTRACT

Auto-complete lists that are utilized by server-deployed client processes are provided. The auto-complete lists are utilized by a client process to provide a list of potential data records that may match a data record that is partially entered into an input field by a user. The user may either continue to type in a complete data record into the input field, or alternatively, select a displayed data record contained in the auto-complete list for entry in the input field.

### TECHNICAL FIELD

Embodiments of the present invention relate to the field of generating an auto-complete data entry feature for user applications. In particular, embodiments of this invention relate to centralized storage of auto-complete data that may be remotely accessed by server-deployed client processes.

### BACKGROUND OF THE INVENTION

Some known systems provide auto-complete lists for use by client applications that reside on client computing devices. An example of such a system is the Outlook® email application (Microsoft Corp., Redmond, Wash.). The email application, when executed, provides an auto-complete list of email recipients as the user begins to enter data into an input field for a recipient's email address. The email application displays a list of recipients from which the user can select for entry into the input field that partially or completely match the data entered by the user. If the user enters a new recipient that is not present on the auto-complete list, the new recipient may be added to the auto-complete list for subsequent access.

These systems, however, do not allow a user to obtain a consistent auto-complete list when using a different computing device that does not have the application software residing on the specific computing device.

Accordingly, there is a need for a system and method for a server-deployed client process wherein an auto-complete list from a central storage location is provided to a client computing device. Such a system would provide a user the advantage of access to centralized data that is not machine dependent. Such a system would further provide an advantage of a consistent auto-complete list that is centrally updated, and therefore current, independent of the computing device utilized to execute the server-deployed client process.

### SUMMARY OF THE INVENTION

The present invention overcomes the deficiencies of the known art by providing a user a centralized auto-complete list that may be accessed by executing a server-deployed client process from a computing device having access to the server. In accordance with aspects of the invention, the centrally stored auto-complete list remains consistent and up-to-date independent of the computing device that accesses the server.

In accordance with the present invention, one aspect provides a computer-implemented method for generating an auto-complete list. A server-deployed client process is executed via a data communication network for displaying an input field to a user wherein the client process is executed at a client computer coupled to the network. The method includes receiving data from a user via the input field and retrieving an auto-complete list having one or more data records from a centralized storage location remote from the client computer coupled to the network in response to the data received from the user. The method also includes identifying a first set of data records from the data records of the auto-complete list that correspond to the data in the input field.

Another aspect of the present invention includes a client and server system. The system comprises one or more clients coupled to a data communication network. A server is also coupled to a data communication network, wherein the server is configured to execute computer-executable instructions for sending an auto-complete list to a requesting client. A server memory area associated with the server for central storage of one or more auto-complete lists. The system further includes a client memory area associated with the requesting client for storing an auto-complete list and data input from a user. The requesting client is configured to execute computer-executable instructions for executing a client application having an input field; requesting an auto-complete list from a server remote from the client; receiving the auto-complete list from the server, said auto-complete list having one or more data records; receiving data from a user via the input field; and identifying data records from the data records of the auto-complete list that correspond to the data in the input field.

Computer-readable media embodying aspects of the invention for generating an auto-complete list for a user from a remote centralized storage location, includes a memory component for storing an auto-complete list; an interface component for receiving data input from a user and requesting and receiving an auto-complete list from a remote centralized storage location. The computer readable media further includes a processor component for executing a process having an input field; receiving the auto-complete list from the centralized storage location, the auto-complete list having one or more data records; and identifying a set of data records from the data records of the auto-complete list that correspond to the data input into the data field.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary embodiment of a block diagram illustrating an exemplary embodiment of a suitable computing system environment in which one embodiment of the invention may be implemented.

FIG. 2 is a diagram of one embodiment of the present invention that illustrates the locations where the auto-complete list exists in the central storage location, the server, and the client.

FIG. 3 is a block diagram illustrating one example of a suitable computing system environment in which the invention may be implemented.

FIG. 4 is an illustration of an exemplary drop-down menu of an auto-complete list of email recipients.

Corresponding reference characters indicate corresponding parts throughout the drawings.

### DETAILED DESCRIPTION OF THE INVENTION

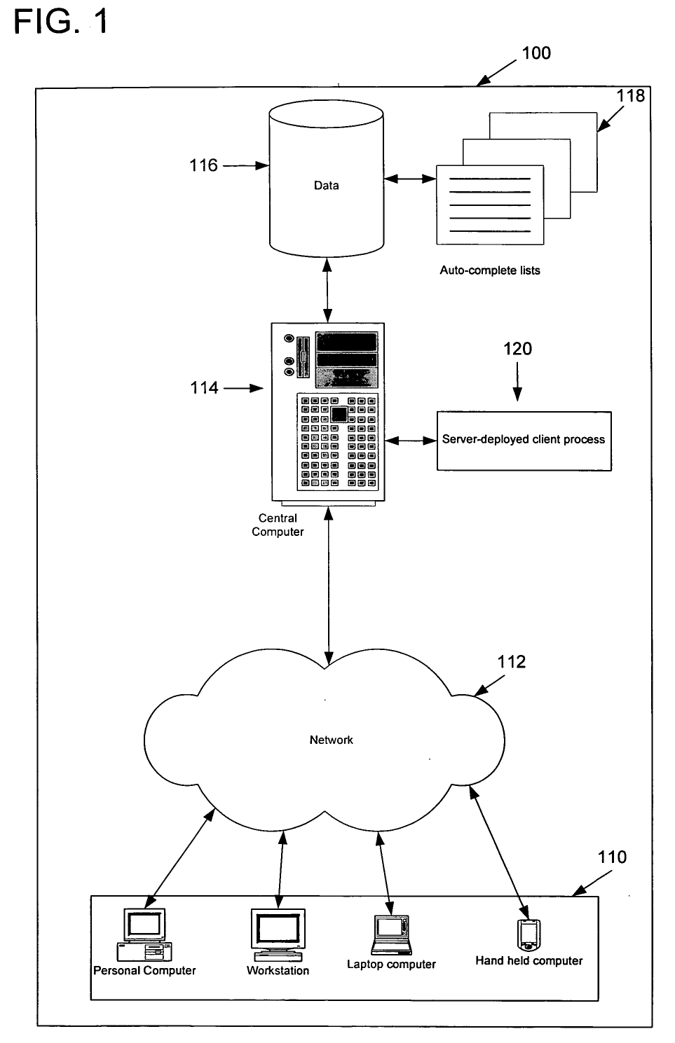

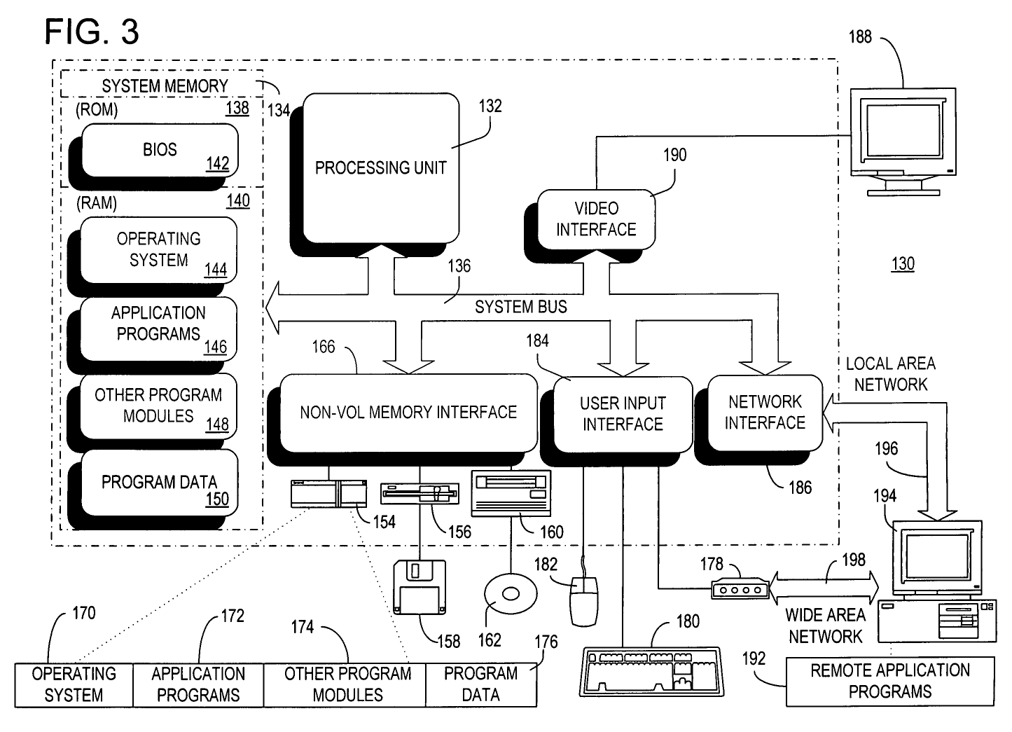

Referring first to FIG. 1, a block diagram illustrates an exemplary embodiment of a suitable computing system environment in which one embodiment of the invention may be implemented. A system 100 has one or more computing devices 110 having access to network 112. Network 112 in turn permits computing devices 110 to access a central computer 114 (e.g., computer 130 of FIG. 3). Central computer 114 has access to a central storage location 116 wherein data 118 may be stored. A user may execute client process 120 utilizing a computing device 110 which accesses central computer 114 via network 112. Upon request of computing device 110, central computer 114 deploys client process 120. The client process 120 permits computing device 110 to request and receive access to data 118 stored in the central storage location 116 through central computer 114. This system therefore permits a user to access data from the central storage location 116, regardless of which individual computing device 110 is used, as long as computing device 110 has access to network 112.

The present invention, in particular, relates to an auto-complete list of data records stored in central storage location 116 that can be utilized in a server-deployed client process. A user utilizes computing device 110 having access to network 112 to execute the server-deployed client process. The server-deployed client process embodying aspects of the invention displays an input field in which the user can enter data. During execution of the process, the server, such as central computer 114, sends the computing device an auto-complete list of data records that corresponds to data which the user may enter in the input field. As the user enters data into the input field, process 120 compares the entered data to the data records contained in the auto-complete list. If the entered data is contained in one or more data records in the auto-complete list, the process 120 displays the matching data records via computing device 110. The user can then select one of the displayed data records wherein the selected data record is then entered into the input field.

Aspects of the present invention thereby provide the user with a list of possible complete records that may correspond to a partial data record that the user enters into the input field. For example, if the input field is used to enter the name of a city, the user may first enter the letter “C” wherein the process would display a list of potential cities such as “Chicago,” “Cincinnati,” “Cleveland,” “Clearwater,” and so forth. The user, instead of typing the entire name, can simply select one of the names on the auto-complete list and the process 120 will enter the selected city in the input field. If the user proceeds to enter the partial record “CL,” process 120 would compare the entered characters with the auto-complete list and display a reduced set of data records that still match the partial record that is entered. In this example, process 120 displays the reduced set of “Cleveland” and “Clearwater” from which the user can select.

If the auto-complete list does not contain the correct data record that the user is entering into the input field, the user can enter the complete data record into the input field. For example, the user enters the city name “Clayton” into the input field. The process 120 then provides the newly entered data to the central computer 114 which in turn updates the auto-complete list stored in the central storage location 116. Thereafter, when process 120 is executed in the future, if the user enters the letter “C” into the input field, the auto-complete list provided to process 120 would include “Clayton” in the displayed list of data records from which the user can select.

The server-deployed client processes which may utilize the auto-complete list of the present invention include any server-deployed client process wherein a user enters data into an input field. Non-limiting examples of such processes include network access email programs which contain input fields for a recipient's email address (e.g., Outlook Web Access®, Microsoft Corporation, Redmond, Wash.); search engine programs which contain input fields for terms to be searched (e.g., MSN® Search, Microsoft Corporation, Redmond, Wash.); web-based multimedia applications; online directory applications; map and location applications; information obtaining programs which provide input fields for a user to complete such as purchasing, recruitment, financial, or medical forms wherein a user enters common information such as name, address, job title, medical condition; and the like.

The auto-complete list feature thus permits a user to quickly enter data as well as improves the quality of the data entered by reducing typographical errors. A user may execute the server-deployed client process through various methods known to those skilled in the art, which include server-deployed programs that, when executed, are displayed in a browser window of a user's computing device.

Upon execution of the server-deployed client process, the auto-complete list may be provided by the server (e.g., central computer 114) to the process in a number of manners. In one embodiment, after the user executes the server-deployed client process, the process 120 requests central computer 114 to send a form, page, or other data input display (hereinafter collectively referred to as the “form”) comprising a data entry input field. The user can then begin entering data into the input field of the form. Once the form is displayed in the user computing device 110, the process 120 requests central computer 114 to send an auto-complete list associated with the form. When the user's computing device 110 receives the auto-complete list from computer 114, it stores it in memory. The process 120 then can compare data the user enters in the input field to the data records present in the auto-complete list. Thus, in this embodiment, two requests are sent to central computer 114 (i.e., the server). In another embodiment, after the user executes the server-deployed client process, the process 120 makes a single request to central computer 114 to send both the form and the auto-complete list at the same time. While this embodiment requires only a single request from computer 114 rather than two, the server response can sometimes be slower than when two requests are sequentially made.

In one embodiment, the auto-complete list provided to the user is a unique list of data records that are commonly used by a specific user. In this embodiment, the user would provide a unique identifier when executing the process 120 such as the user's name or password. The process 120 would then obtain an auto-complete list of terms which the user has entered in the input field in the past. Thus, the auto-complete list would be customized to the user by containing only data records that the user had previously entered in the input field.

In another embodiment, the auto-complete list provided to the user is a unique list of data records that are commonly used by a group in which the user is a member. The user would provide an identifier that is unique to the group, such as the group's name, department, or password when executing process 120. Process 120 would then obtain an auto-complete list of terms which the group has entered in the input field in the past. In this embodiment, the auto-complete list would benefit the user by enabling the selection of data records that have been used by the group in the past without the user being required to know the complete record. For example, an auto-complete list of email addresses commonly used by a group would allow an individual to select the email address for a recipient without the individual being required to know the complete email address, or without requiring the individual to personally enter the email address first.

In another embodiment, the auto-complete list is provided to process 120 and stored in the computing device's memory during execution of the process. When process 120 is terminated, the auto-complete list is deleted from memory without being saved to a hard drive or other long-term storage device where other individuals could subsequently view the user-specific information. This embodiment provides a number of advantages to a user. The user gains the flexibility of accessing a user-specific auto-complete list from any multiple-user computing device having access to a network, e.g., a community, work, or library personal computer used by number of people. The user also can access their personal auto-complete list without potentially compromising the privacy of the user-specific information.

According to other aspects of the invention, the user specific auto-complete list comprises a limited number of most recently used records or commonly used records. By limiting the size of the auto-complete list, the time required to provide the auto-complete list to process 120 as well as the time required to search through the list for potentially matching records can be reduced. For example, the auto-complete list can be structured to contain a list of up to 50 of the most recently used data records that were previously entered by the user. Alternatively, larger or smaller list sizes can be included in the auto-complete lists (e.g., up to 1000, 100, 40, 30, 25, etc. of the user's most recently used data records).

In another embodiment, users have the ability to delete entries from the auto-complete list. To do this, the user can simply use a mouse or the arrow keys to select the entry in the menu they want to delete, highlight, or select the entry, and hit the “delete” key. A request is sent to central computer 114, which loads the auto-complete list, deletes the entry, and then saves it. This “delete entry” operation can update the client copy of the auto-complete list that is currently loaded in the memory of the user's computing device. Thus, the client copy of the auto-complete list is kept “in sync” with the server.

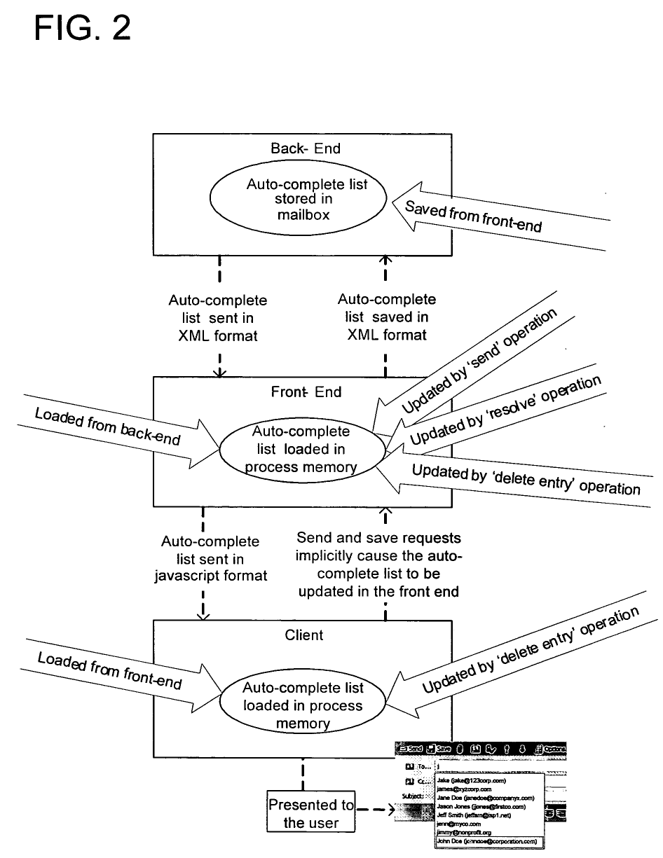

FIG. 2 is a diagram of one embodiment of the present invention that illustrates the locations where the auto-complete list exists in the central storage location, the server, and the client. FIG. 2 further illustrates the data flow as well as the operations that affect the different instances of the auto-complete list as highlighted with large arrows. This embodiment is described in greater detail below in Example 2.

FIG. 3 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 3 illustrates operating system 144, application programs 146, other program modules 148, and program data 150.

The computer 130 may also include other removable/non-removable, volatile/nonvolatile computer storage media. For example, FIG. 3 illustrates a hard disk drive 154 that reads from or writes to non-removable, nonvolatile magnetic media. FIG. 3 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 3, provide storage of computer readable instructions, data structures, program modules and other data for the computer 130. In FIG. 3, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 3 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 3 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions.

One aspect of the present invention includes a computer-implemented method for generating an auto-complete list. The method comprises a server-deployed client process 120 being executed via a data communication network 112. Client process 120 is executed by a client computer 110 coupled to network 112 for displaying an input field to a user. Data is received from the user via the displayed input field. An auto-complete list 118 is received from a centralized storage location 116 that is coupled to network 112 in response to the data received from the user via the input field. Centralized storage location 116 is remote from client computer 110. Auto-complete list 118 contains one or more data records. A first set of data records is identified from the data records of auto-complete list 118 that correspond to the data in the input field.

Another aspect of the present invention includes a client and server system. The system comprises one or more clients coupled to a data communication network 112. A server 114, also coupled to data communication network 112, is configured to execute computer-executable instructions for sending an auto-complete list 118 to a requesting client computer 110. Server 114 comprises a server memory area for central storage of one or more auto-complete lists 118. A client memory area is associated with requesting client computer 110 for storing auto-complete list 118 and data input from a user. Requesting client computer 110 is configured with a processor to execute computer-executable instructions for executing a client application 120, which is deployed by server 114, wherein client application 120 contains an input field. The client processor requests auto-complete list 118 from server 114 remote from client computer 110 and receives auto-complete list 118 from server 114. Auto-complete list 118 comprises one or more data records. The client computer processor receives data from a user via the input field and identifies data records from auto-complete list 118 that correspond to the data in the input field.

Still another aspect of the present invention includes one or more computer-readable media having computer-executable components for generating an auto-complete list 118 for a user from a remote centralized storage location 116. The components comprises a memory component for storing auto-complete list 118; an interface component for receiving data input from a user and requesting and receiving auto-complete list 118 from remote centralized storage location 116; and a processor component. The processor component executes a process having an input field; receives auto-complete list 118, having a one or more data records, from centralized storage location 116; and identifies a set of data records from the data records of auto-complete list 118 that correspond to the data input into the data field.

The following examples further illustrate aspects of the invention.

### EXAMPLE 1

### Remotely Accessed Email Addressee Auto-Complete List

In one embodiment, the present invention can be used to provide a user an auto-complete list or auto-complete cache for a network-related application, for example, Outlook Web Access® (OWA) product (Microsoft, Corp., Redmond, Wash.), network search engines, or other browser-related application. Those skilled in the art are familiar with OWA as a web application that gives users access to their Microsoft Exchange Server® mailboxes (Microsoft, Corp., Redmond, Wash.), and the ability to send and receive email, scheduling appointments and other Personal Information Management (PIM) tasks alike. It is designed to run on a browser and be a companion to Outlook® program (Microsoft, Corp., Redmond, Wash.) email, which is a desktop PIM client application.

In one embodiment, OWA is designed on top of ASP.NET on the server and makes extensive use of the DHTML capabilities of the Internet Explorer 6 browser (Microsoft, Corp., Redmond, Wash.) on the client.

OWA allows users to send email messages to recipients. To do this, a user would open new email form, type in the recipient names, resolve them, and then send the message. Resolving a recipient name is a process by which the application maps any name to an actual email address that uniquely identifies the recipient of the message. Thus, a user would not need to type the email address of the recipient to send the message, instead they can alternatively type a recipient's name (or part of thereof), an alias, or just a part of the email address. The software will then attempt to resolve or map the information provided by the user to an actual email address. In order to do the name resolution, the application looks in several locations where recipient information is stored, such as the Active Directory or the contacts file of the sender.

An illustrative example of this scenario is a user that wants to send a message to “johndoe@corporation.com”. She opens the new email form of OWA, then types “john” in the recipient well (the textbox in the User Interface (UI) where users type the recipient names), and clicks on the “send” button. At this point, the application will try to resolve the name “John Doe” to an actual email address. In this example, since there is only one recipient whose name is “John Doe” in the Active Directory, there is a unique match and the email address used is johndoe@corporation.com, which corresponds to the “John Doe” user in the directory. A recipient auto-complete cache is a mechanism that is implemented on top of all of this that allows users to be presented with a list of potential pre-resolved recipients as they type in the name. This list is built using historical information (as the user sends email to this recipients, the application remembers the names). For example, if an email was sent to “John Doe” and “Jane Doe” in the past, the email addresses would likely be present in the user's auto-complete list. This means, next time the user sends a message, inputting the letter “J” in the email recipient field, OWA will display a drop-down menu listing both “Jane Doe,” “John Doe,” and any other recipients beginning with the letter “J” as potential recipients for the email message. If the user proceeds to type “Jo,” the list of potential recipients is reduced to “John Doe.” The application tries to determine the name of the recipient the user is typing and presents the choices so the user can simply select a name from the drop-down menu to add this pre-resolved recipient quickly, instead of typing the name and resolve it. Thus, the application aids the user by providing likely recipients from the auto-complete list and helps reduce time needed to enter recipients for email messages.

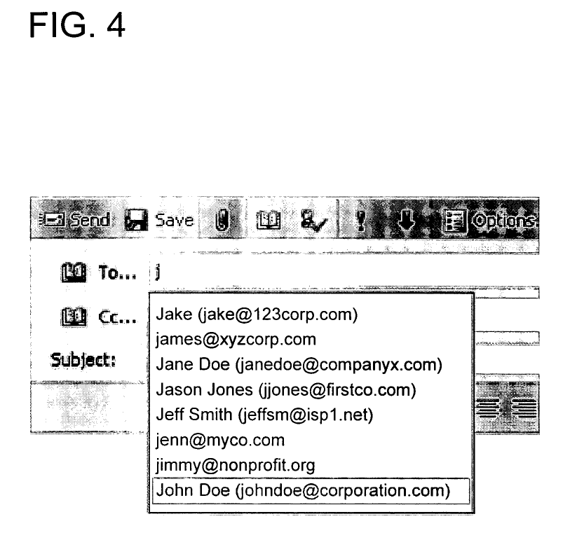

An illustration of an exemplary drop down menu of the auto-complete list of email recipients is provided in FIG. 4.

The auto-complete list is stored in the server so it's accessible for users anywhere as long as they have access to OWA. The present invention sends the auto-complete list to the client using HTTP in the background when the new email form loads. The list is then available to be used by the email form which displays a drop-down menu with the auto-complete list of recipients.

### EXAMPLE 2

### Architecture for Providing Auto-Complete List to a User

OWA has a three-tier architecture: back-end, front-end, and client. FIG. 2 is an illustration of the architecture detailing the locations where the auto-complete list exists in the central storage location, the server, and the client. FIG. 2 further illustrates the data flow as well as the operations that affect the different instances of the auto-complete list as highlighted with large arrows.

The back-end stores the data while the front-end contains the business logic to process this data and present it to the client. OWA is present or “lives” in the front-end tier. Thus, the auto-complete list exists in three different places, and in three different forms. In the back-end, the list is stored in XML format in the mailbox of the user. When a request is received from the client, the auto-complete is accessed from the back-end and passed to the front-end where it is loaded in a data structure in memory. In the client, the list is loaded in the computing device memory in JavaScript data structures.

Since there are two communication channels (back-end to front-end, front-end to client), the list is sent in two different formats. Between the back-end and the front-end, the list is sent back and forth in XML format. This format is also used to store the list. From the front-end to the client, the list is sent in JavaScript format, which is executed in the client.

Each entry in the list contains the pre-resolved data for the recipient such as display name, alias, and email address. The list may contain a limited number of recipient entries. For example, the list can have a maximum size of 50 entries. In such a structure, there must therefore be a decay algorithm to choose which entries to keep on the list and which to disregard when the list is reaches its maximum size and the user types in a new recipient. In one such algorithm a usage count for each entry is maintained wherein the usage count is incremented every time that a recipient is used and initialized to some value when the user is added for the first time. The usage count is also decremented using some rules based on how many sessions passed since the entry was last used. Entries then are sorted using the usage count as well as a time stamp corresponding to the last time the entry was used. When a new entry comes into the list, the list is re-sorted and the last entry is removed to make room for the new one.

Entries are added to the list every time a recipient is resolved. As previously stated, a recipient is resolved when a user enters the recipient for the first time. If an entry exists already in the list for that recipient, then its usage count and time stamp are updated.

The usage count of recipients is updated in three cases:

When the recipient is resolved.

When the recipient is added using the auto-complete menu.

When the recipient is added from an address book (the address book is a feature of an email application, such as OWA, that shows the users a list of their contacts as well as the other users in the directory of their organization).

When a recipient is resolved, the usage count is simply updated in the server. When the recipient is added using auto-complete or the address book, there is no round-trip to the server involved like there is for the name-resolution case. Rather, a flag is set in the recipients in the client in order to update their entries in the list later, once the server is contacted during the send operation.

### EXAMPLE 3

### Auto-Complete Process in a Server-Deployed Client Email Application

As previously described, the present invention may be implemented in a number of network or web-related applications. One such application is that of a web-based email application. An example of the process flow for such an application is provided below.

A user starts a new client OWA session, opens a new message form in order to create and send a new email message.

The email form is downloaded and displayed to the user. At this point the recipient auto-complete list has not yet been received from the server. However, the user can start typing in the recipient wells (i.e., input fields).

After the form is downloaded, the client sends a background request to the server to retrieve the auto-complete list. The server code loads the list in XML format from the back-end and into a data structure in memory in the front-end. Then renders it into JavaScript format and sends it to the client as the response of the request. The client executes this JavaScript code and now the list is available for use in the client's memory.

The user starts typing in a recipient name, types the character “J”.

The script code looks for matches in the cache for the letter “J”. It does this by looking at the email address, display name and alias of all the entries. Since there are two matches (“John Doe” and “Jane Doe”), a drop down menu is displayed under the recipient well with these two choices.

The user now uses the down arrow to select “John Doe” and presses the “enter” key. Now “John Doe” is a recipient for the message. The client also sets a flag for the “John Doe” entry to remember to update it in the server list later.

The user now types the character “L.” The script code can't find any entries in the list having an alias, email address, or display name that starts with the letter “L,” so no list is displayed.

The user continues typing and enters “Linda,” then clicks on the “Resolve” button.

A name resolution request is sent to the server. The server code resolves “Linda” to the recipient with alias “t-linda” in the active directory. Then loads the auto-complete list from the backend, and adds an entry for “Linda” to it. At this point the copy of the auto-complete list in the client is not updated. The updated list will be available for the next time the user opens a new mail form.

Finally, the user clicks on “send” to send the message. This sends a request to the server with the data necessary for sending the email message, including the list of recipients. In our example, “John Doe” and “Linda” are the recipients. The code to do the “send” operation loops through this list and checks to see whether a flag indicating that the recipient's entry must be updated in the cache is set, which is the case for “John Doe.” This updates the usage count for “John Doe” in the auto-complete list.

The auto-complete list is loaded from the backend whenever is needed and then saved back. The auto-complete list is not stored in memory in between requests. The reason for this feature is scalability (i.e., saving memory in the server).

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A computer-implemented method for generating an auto-complete list, said method comprising:
executing a server-deployed client process via a data communication network for displaying an input field to a user, said client process being executed at a client computer coupled to the network;
receiving data from a user via the input field;
retrieving an auto-complete list from a centralized storage location coupled to the network in response to the data received from the user via the input field, said centralized storage location being remote from the client computer, said auto-complete list having one or more data records;
identifying a first set of data records from the data records of the auto-complete list that correspond to the data in the input field.

2. The method of claim 1, wherein data received from the user via input field comprises a partial data record of one or more characters.

3. The method of claim 2, further comprising receiving additional data from the user via the input field, and identifying a second set of data records from the plurality of data records of the auto-complete list that correspond to the data in the input field.

4. The method of claim 3, wherein the second set of data records is a subset of the first set of data records, the second set of data records comprising at least one less data record than the first set of data records.

5. The method of claim 1, wherein the auto-complete list comprises a list of most recently used data records.

6. The method of claim 5, wherein the auto-complete list comprises a list of most recently used data records associated with the user.

7. The method of claim 1, wherein the user selects a complete data record from the first set of data records for entry into the input field.

8. The method of claim 1, further comprising receiving the auto-complete list into memory and further deleting the auto-complete list from the memory after the execution of the process is terminated.

9. The method of claim 1, further comprising updating the remote centralized storage location's auto-complete list of data records with a complete data record received via the input field, wherein the complete data record is not present in the auto-complete list.

10. The method of claim 1, wherein the server-deployed client process is selected from the group consisting of email applications, search engine programs, online multimedia programs, web-based multimedia applications, online directory applications, map and location applications, and information obtaining programs.

11. The method of claim 1, wherein one or more computer-readable media have computer-executable instructions for performing the computer-executable method of claim 1.

12. A client and server system comprising:
one or more clients coupled to a data communication network;
a server also coupled to a data communication network, said server being configured to execute computer-executable instructions for sending an auto-complete list to a requesting client;
a server memory area associated with the server for central storage of one or more auto-complete lists;
a client memory area associated with the requesting client for storing an auto-complete list and data input from a user; and
wherein said requesting client is configured to execute computer-executable instructions for:
executing a client application having an input field;
requesting an auto-complete list from a server remote from the client;
receiving the auto-complete list from the server, said auto-complete list having one or more data records;
receiving data from a user via the input field; and
identifying data records from the data records of the auto-complete list that correspond to the data in the input field.

13. The system of claim 12, wherein the auto-complete list comprises a list of most recently used data records associated with the user.

14. The system of claim 12, wherein the client is further configured to execute computer-executable instructions for receiving the auto-complete list into the client memory area and further deleting the auto-complete list from the client memory area after the execution of the process is terminated.

15. The system of claim 12, wherein the server is further configured to execute computer-executable instructions for updating the auto-complete list of data records with a complete data record received from the client, wherein the complete data record was not present in the auto-complete list received from the server.

16. One or more computer-readable media having computer-executable components for generating an auto-complete list for a user from a remote centralized storage location, said components comprising:
a memory component for storing an auto-complete list;
an interface component for receiving data input from a user and requesting and receiving an auto-complete list from a remote centralized storage location; and
a processor component for:
executing a process having an input field;
receiving the auto-complete list from the centralized storage location, said auto-complete list having one or more data records; and
identifying a set of data records from the data records of the auto-complete list that correspond to the data input into the data field.

17. The method of claim 16, wherein the processor component is configured to execute computer-executable instructions for receiving additional data from the user via the input field and identifying a reduced set of data records from the plurality of data records of the auto-complete list that correspond to the additional data.

18. The method of claim 16, wherein the auto-complete list comprises a list of most recently used data records associated with the user.

19. The method of claim 16, further comprising a processor component configured to execute computer-executable instructions for receiving the auto-complete list into memory and further deleting the auto-complete list from the memory after the execution of the process is terminated.

20. The method of claim 16, wherein the server-deployed client process is selected from the group consisting of email applications, search engine programs, online multimedia programs, web-based multimedia applications, online directory applications, map and location applications, and information obtaining programs.
